(19) United States
(12) Patent Application Publication
(10) Pub. No.: US 2025/0095329 A1
(43) Pub. Date: Mar. 20, 2025

(54) DYNAMIC NEURAL NETWORKS FOR TEMPORAL FEATURE ALIGNMENT IN ASYNCHRONOUS MULTI-SENSOR FUSION SYSTEMS

(71) Applicant: QUALCOMM Incorporated, San Diego, CA (US)

(72) Inventors: Kiran Bangalore Ravi, Paris (FR); Julia Kabalar, München (DE); Nirnai Ach, Munich (DE); Mireille Lucette Laure Gregoire, Stuttgart (DE); Senthil Kumar Yogamani, Headford (IE)

(21) Appl. No.: 18/469,863

(22) Filed: Sep. 19, 2023

(51) Int. Cl. G06V 10/44; G06V 10/82

(52) U.S. Cl. CPC G06V 10/44; G06V 10/82

(57) ABSTRACT

A device for processing sensor data is configured to receive the first frames from a first sensor; receive the second frames from a second sensor; perform a first feature extraction on the first frames using a first dynamic neural network to determine first features; perform a second feature extraction on the second frames using a second dynamic neural network to determine second features; determine a first delay associated with the first features; determine a second delay associated with the second features; modify a topology of the second dynamic neural network based on the first delay and the second delay; and use the second dynamic neural network with the modified topology to generate an output.

### TECHNICAL FIELD

This disclosure relates to moving object segmentation systems, including moving object segmentation used for advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indicative of the existence and location of other objects around the autonomous driving vehicle. In some examples, such an autonomous driving vehicle may be referred to as an ego vehicle. A vehicle having an ADAS is a vehicle that includes systems which may assist a driver in operating the vehicle, such as parking or driving the vehicle.

### SUMMARY

By fusing the data gathered from camera, LiDAR, radar, and other sensors, an advanced driver-assistance systems (ADAS) can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

The various sensors may transmit frames of data to centralized processing circuitry, e.g., a system on a chip (SOC), that performs feature extraction to determine feature maps and fuse the feature maps of different sensors. The SOC may, for example, perform feature extraction separately for each modality of sensor using a different neural network for each modality of sensor. These different neural networks may each have different processing delays, which may also be referred to as inference delays. Additionally, the various sensors may each have internal processing delays and be connected to the SOC using cables of different types and lengths as well as different connectors and other hardware. These hardware differences may lead to different sensors also having different path delays, meaning the time for the data to be transmitted from the sensor to the SOC may be different. The combination of these internal delays and path delays may be referred to herein as time-of-issue delays.

To combine features, it is generally desirable to have spatial and temporal alignment, so that features correspond to the same 3D space. Hardware synchronization, e.g., buffering, can be used to achieve synchronization, but in ADAS applications, data needs to be processed as fast as possible so the ADAS can respond rapidly to changes in vehicle environment. Too much buffering may result in the ADAS responding to hazards or other dangers slower, which can reduce safety performance. Hardware synchronization may also not appropriately adapt to types of delay that vary from one installation to another.

The neural networks may be trained to correct for some amount of delay, but if the delay changes after training, then the corrections may become ineffective. Certain types of delay, such as path delay may be different from installation to installation due to, for examples, sensors being installed with different cable types, cable lengths, connectors, or other variations. In some situations, new sensors with faster processing may replace older sensors during the life of an ADAS. Due to these factors and others, the actual delay in a system may end up being different than the delay used during training of the neural networks.

To address the problems introduced above, this disclosure describes techniques for using dynamic neural networks (DNNs) that are dynamic at runtime, not just during training. A system implementing the techniques of this disclosure may be configured to determine, for a plurality of sensors or a plurality of sensor modalities, a total delay associated with determining features for a particular sensor. The total delay may be determined based on one or more of internal processing delays associated with a sensor, a path delay associated with the sensor, or an inference delay of a DNN used for data of the sensor. A system of this disclosure may modify the topology of one or more DNNs based on the determined delays in order to reduce the differences in total delay between the various sensors. By reducing the differences in delays for different sensors, the system may improve the synchronicity of multiple sensors, which improves feature alignment for features extracted from frames obtained by the various sensors.

For an ADAS, improved feature alignment generally results in improved system performance downstream of feature extraction. For example, improved feature alignment may produce better fusion of features, which produces more accurate object detection and tracking, which in turn may enable the ADAS to navigate more safely.

According to an example of this disclosure, a system includes one or more memories configured to store first frames of data and second frames of data; and processing circuitry configured to: receive the first frames from a first sensor; receive the second frames from a second sensor; perform a first feature extraction on the first frames using a first dynamic neural network to determine first features; perform a second feature extraction on the second frames using a second dynamic neural network to determine second features; determine a first delay associated with the first features; determine a second delay associated with the second features; modify a topology of the second dynamic neural network based on the first delay and the second delay; and use the second dynamic neural network with the modified topology to generate an output.

According to an example of this disclosure, a method includes receiving, at processing circuitry, first frames from a first sensor; receiving, at the processing circuitry, second frames from a second sensor; performing a first feature extraction on the first frames using a first dynamic neural network to determine first features; performing a second feature extraction on the second frames using a second dynamic neural network to determine second features; determining a first delay associated with the first features; determining a second delay associated with the second features; modifying a topology of the second dynamic neural network based on the first delay and the second delay; and using the second dynamic neural network with the modified topology to generate an output.

According to an example of this disclosure, a computer-readable storage medium stores instructions that when executed by one or more processors cause the one or more processors to receive first frames from a first sensor; receive second frames from a second sensor; perform a first feature extraction on the first frames using a first dynamic neural network to determine first features; perform a second feature extraction on the second frames using a second dynamic neural network to determine second features; determine a first delay associated with the first features; determine a second delay associated with the second features; modify a topology of the second dynamic neural network based on the first delay and the second delay; and use the second dynamic neural network with the modified topology to generate an output.

The details of one or more examples are set forth in the accompanying drawings and the description below. Other features, objects, and advantages will be apparent from the description, drawings, and claims.

### BRIEF DESCRIPTION OF DRAWINGS

FIGS. 1A and 1B show an example advanced driver-assistance systems (ADAS) in accordance with the techniques of this disclosure.

FIG. 2 is a block diagram illustrating an example processing system according to one or more aspects of this disclosure.

FIG. 3 is a block diagram illustrating an encoder-decoder architecture for processing image data and position data to generate an output, in accordance with one or more techniques of this disclosure.

FIG. 4 is a flowchart illustrating an example process for modifying a dynamic neural network during runtime.

### DETAILED DESCRIPTION

Camera and LiDAR systems may be used together in various different robotic and vehicular applications. One such vehicular application is an advanced driver assistance system (ADAS). ADAS is a system that utilizes camera, LiDAR, and other sensor technology to improve driving safety, comfort, and overall vehicle performance. This system combines the strengths of multiple sensors to provide a more comprehensive view of a vehicle's surroundings, enabling the ADAS to better assist the driver in various driving scenarios.

In some examples, the camera-based system is responsible for capturing high-resolution images and processing the images in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and positioning of objects around the vehicle. LiDAR sensors provide 3D data, enabling the ADAS to create a detailed map of the surrounding environment. LiDAR may be particularly effective in low-light or certain adverse weather conditions, where camera performance may be hindered. In some examples, the output of a LiDAR sensor may be used as partial ground truth data for performing neural network-based depth information on corresponding camera images.

Radio detection and ranging (radar) sensors transmit high-frequency radio waves and receive reflections of the transmitted waves. By measuring a return time and a frequency shift of the return signals (i.e., the reflections), a distance, speed, direction, size, shape, and other characteristics of an object can be detected. Types of radar include pulse radar and continuous wave radar. Radar may provide a doppler velocity of a detected object. As radar directly determines velocity, instead of for example through image analysis, radar may determine velocity more quickly and more accurately than cameras and LiDAR, and thus may generate an output that can compliment cameras and LiDAR in an ADAS.

By fusing the data gathered from camera, LiDAR, radar, and other sensors, the ADAS can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

The various sensors may transmit frames of data to centralized processing circuitry, e.g., a system on a chip (SOC), that performs feature extraction to determine feature maps and fuse the feature maps of different sensors. The SOC may, for example, perform feature extraction separately for each modality of sensor using a different neural network for each modality of sensor. These different neural networks may each have different processing delays, which may also be referred to as inference delays. Additionally, the various sensors may each have internal processing delays and be connected to the SOC using cables of different types and lengths as well as different connectors and other hardware. These hardware differences may lead to different sensors also having different path delays, meaning the time for the data to be transmitted from the sensor to the SOC may be different. The combination of these internal delays and path delays may be referred to herein as time-of-issue delays.

To combine features, it is generally desirable to have spatial and temporal alignment, so that features correspond to the same 3D space. Hardware synchronization, e.g., buffering, can be used to achieve synchronization, but in ADAS applications, data needs to be processed as fast as possible so the ADAS can respond rapidly to changes in vehicle environment. Too much buffering may result in the ADAS responding to hazards or other dangers too slowly, which can reduce safety performance. Hardware synchronization may also not appropriately adapt to types of delay that vary from one installation to another.

The neural networks may be trained to correct for some amount of delay, but if the delay changes after training, then the corrections may become ineffective. Certain types of delay, such as path delay may be different from installation to installation due to, for examples, sensors being installed with different cable types, cable lengths, connectors, or other variations. In some situations, new sensors with faster processing may replace older sensors during the life of an ADAS. Due to these factors and others, the actual delay in a system may end up being different than the delay used during training of the neural networks.

To address the problems introduced above, this disclosure describes techniques for using dynamic neural networks (DNNs) that are dynamic at runtime, not just during training. A system implementing the techniques of this disclosure may be configured to determine, for a plurality of sensors or a plurality of sensor modalities, a total delay associated with determining features for a particular sensor. The total delay may be determined based on one or more of internal processing delays associated with a sensor, a path delay associated with the sensor, or an inference delay of a DNN used for data of the sensor. A system of this disclosure may modify the topology of one or more DNNs based on the determined delays in order to reduce the differences in total delay between the various sensors. By reducing the differences in delays for different sensors, the system may improve the synchronicity of multiple sensors, which improves feature alignment for features extracted from frames obtained by the various sensors.

For an ADAS, improved feature alignment generally results in improved system performance downstream of feature extraction. For example, improved feature alignment may produce better fusion of features, which produces more accurate object detection and tracking, which in turn may enable the ADAS to navigate more safely.

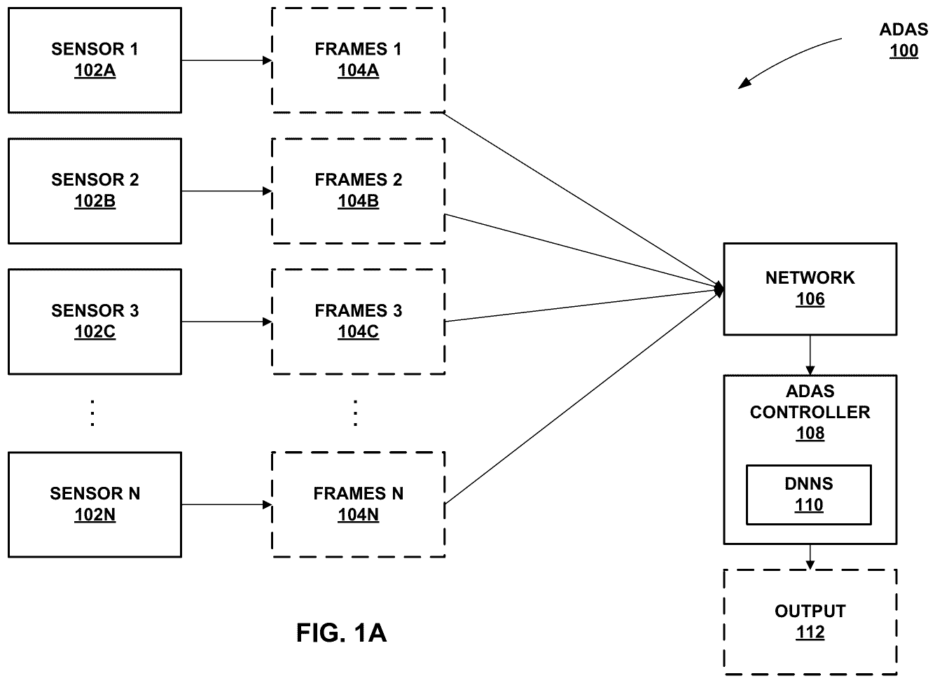

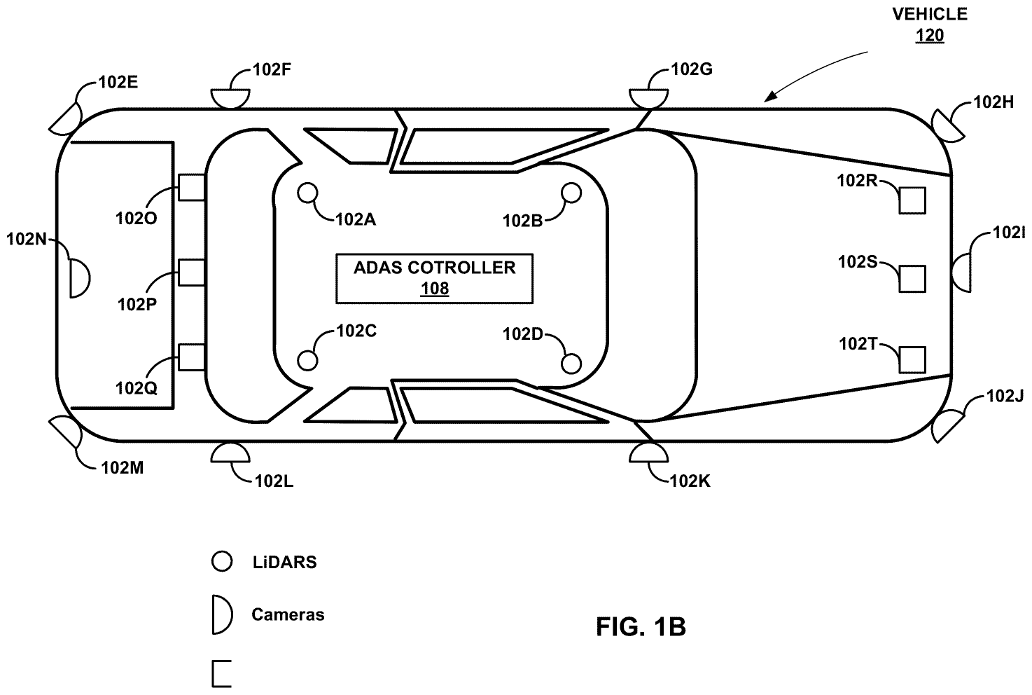

FIG. 1A is a block diagram illustrating an example ADAS according to one or more aspects of this disclosure. ADAS 100 includes N sensors, shown in FIG. 1 as sensors 102A-102N and collectively referred to herein as sensors 102. Sensors 102 may include one or more cameras, one or more LiDARs, one or more radars, and/or one or more other sensors. Each of sensors 102 may acquire frames of data, shown in FIG. 1 as frames 104A-104N and collectively referred to herein as frames 104. Frames 104 are transported, via network 106, to ADAS controller 108. ADAS controller 108 may, for example, include a system on a chip (SOC) or other such processing circuitry for processing frames 104 and generating output 112. As part of processing frames 104. ADAS controller 108 includes a plurality of DNNs 110, with each DNN of DNNs 110 corresponding to a different sensor or sensor group of sensors 102.

FIG. 1B shows an example of ADAS 100 implemented into vehicle 120. In the example of FIG. 1B, sensors 102A-102D are LiDARs, and sensors 102E-102N are cameras. Sensors 1020-102T are radars. Sensors 102A-102T send frames 104 (not shown in FIG. 1B) to ADAS controller 108 via network 106 (not shown in FIG. 1B). ADAS controller 108 is located somewhere in or on vehicle 120. Network 106 generally represents all the cables, connections, and other hardware in or on vehicle 120 that connects sensors 102A-102T to ADS controller 108.

FIG. 1B shows just one example of how ADAS 100 may be implemented into a vehicle. Other combinations and permutations of cameras, LiDARs, and radars, as well as other modalities of sensors, may also be used. Moreover, although vehicle 120 is shown as an automobile in FIG. 1B, it should be understood that ADAS 100 may also be implemented into other types of vehicles, including unmanned aerial vehicles and boats.

Referring back to FIG. 1A, ADAS controller 108 may perform feature extraction on frames 104 using DNNs 110. That is, for feature extraction, the frames of different sensors or sensor groups of sensors 102 may be processed by different DNNs of DNNs 110. DNNs 110 may include convolutional neural networks (CNNs), recurrent neural networks, or other types of neural networks. Each DNN of DNNs 110 may have multiple layers, including an input layer that receives raw input data, an output layer that produces the output of the DNN, and hidden or intermediate layers in between. DNNs 110 may be deep neural networks, meaning the DNNs have many hidden layers. Different DNNs of DNNs 110 may have different depths, meaning the DNNs have different numbers of layers. Deeper neural networks can often times achieve better performance compared to shallower neural networks in terms of producing better outputs, but deeper neural networks also tend to be more difficult to train and have greater inference delays compared to shallower neural networks. An inference delay for one of DNNs 110, for instance, includes a time required to perform feature extraction on frames using that one of DNNs 110. Each layer may perform a specific operation, using for example mathematical transformations involving weighted sums and activations functions, on data received from a previous layer to generate an output for a subsequent layer.

Each DNN of DNNs 110 may have also multiple branches that create different subpaths for data to travel through the neural network. For example, different features related to different aspects of an image, such as edges, textures, objects, etc., may be processed differently by various layers or processed by different layers. The outputs of different branches may also be combined by certain layers. As with layers, neural networks with more branches can often times achieve better performance compared to simpler neural networks, but more branches may also increase inference delays compared to shallower neural networks.

Each DNN of DNNs 110 may also utilize masks to selectively filter or weight certain information before that information is input into a new layer of the DNN. In some examples, the masks may be dynamic, meaning the parameters of the mask are not fixed, but instead vary base characteristics of the input data. Masks can improve neural network performance but also increase inference time.

A module generally refers to a self-contained component of a DNN that performs a specific operation. A module may, for example, be a mask, a layer, or a portion of a layer, or may be a combination of masks, layers, etc.

Each DNN of DNNs 110 may have a different inference delay due to each DNN having a different depth, different branch structure, and different masks. Additionally, different sensors of sensors 102 may have different internal processing delays, and different frames of frames 104 may have different path delays through network 106. Thus, different frames may have different time-of-issue delays depending on the sensor used to acquire the frame and the path through network 106. Thus, the total delay for frames of each of frames 104 may be different depending on which of sensors 102 captured the frame.

To reduce the total delays between different frames of different sensors, ADAS controller 108 may be configured to determine a first delay associated with performing feature extraction, using a first DNN, for a first frame or first group of frames from a first sensor or sensor group and determine a second delay associated with performing feature extraction, using a second DNN, for a second frame or second group of frames from a second sensor or sensor group. In order to reduce a difference between the first delay and the second delay, ADAS controller 108 may modify a topology of the first DNN or the second DNN. To modify the topology of the first DNN or the second DNN, ADAS controller 108 may, for example, change a number of layers being used by the first or second DNN or change a depth of the first or second DNN.

After modifying one or both of the first DNN and the second DNN, ADAS controller 108 may continue to process frames 104, including performing feature extraction with the modified DNN(s), to generate output 112. Output 112 may, for example, be an automatic navigation command for vehicle 120 or some other such command. By reducing the differences in delays for different sensors, the system may improve the synchronicity of various sensors of sensors 102, which may improve feature alignment for features extracted from frames 104, and thus improve the quality of output 112.

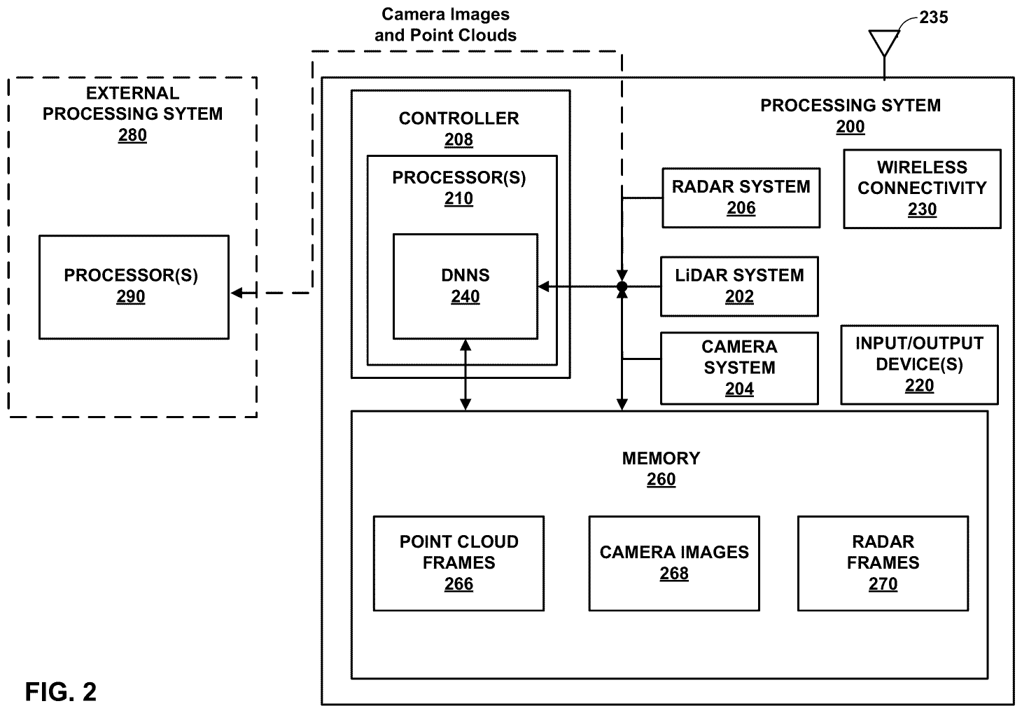

FIG. 2 is a block diagram illustrating an example processing system according to one or more aspects of this disclosure. Processing system 200 may be used in a vehicle, such as an autonomous driving vehicle or an assisted driving vehicle (e.g., a vehicle having an ADAS or an “ego vehicle”). In such an example, processing system 200 may represent an ADAS. In other examples, processing system 200 may be used in other robotic applications that may include both a camera and a LiDAR system. Processing system 200 represents one example of implementation of ADAS 100 described with respect to FIGS. 1A and 1B.

Processing system 200 may include LiDAR system 202, camera 204, radar system 206, controller 208, input/output device(s) 220, wireless connectivity component 230, and memory 260. Processing system 200 may also include additional sensors not shown in FIG. 2. LiDAR system 202 may include one or more light emitters (e.g., lasers) and one or more light sensors. LiDAR system 202 may be deployed in or about a vehicle. For example, LiDAR system 202 may be mounted on a roof of a vehicle, in bumpers of a vehicle, and/or in other locations of a vehicle. LiDAR system 202 may be configured to emit light pulses and sense the light pulses reflected off of objects in the environment. LiDAR system 202 may emit such pulses in a 360 degree field around so as to detect objects within the 360 degree field, such as objects in front of, behind, or beside a vehicle. While described herein as including LiDAR system 202, it should be understood that another distance or depth sensing system may be used in place of LiDAR system 202. The output of LiDAR system 202 are called point clouds or point cloud frames.

A point cloud frame output by LiDAR system 202 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization. Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 204 may be any type of camera configured to capture video or image data in the environment around processing system 200 (e.g., around a vehicle). For example, camera 204 may include a front facing camera (e.g., a front bumper camera, a front windshield camera, and/or a dashcam), a back facing camera (e.g., a backup camera), side facing cameras (e.g., cameras mounted in sideview mirrors). Camera 204 may be a color camera or a grayscale camera. In some examples, camera 204 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

Radar system 206 may include one or more radio wave transmitters and one or more receivers to receive reflections of transmitted radio waves. Based on time differences between transmit and receive, radar system 206 may calculate a distance to an object.

Wireless connectivity component 230 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 230 is further connected to one or more antennas 235.

Processing system 200 may also include one or more input and/or output devices 220, such as screens, touch-sensitive surfaces (including touch-sensitive displays), physical buttons, speakers, microphones, and the like. Input/output device(s) 220 (e.g., which may include an I/O controller) may manage input and output signals for processing system 200. In some cases, input/output device(s) 120 may represent a physical connection or port to an external peripheral. In some cases, input/output device(s) 220 may utilize an operating system. In other cases, input/output device(s) 220 may represent or interact with a modem, a keyboard, a mouse, a touchscreen, or a similar device. In some cases, input/output device(s) 220 may be implemented as part of a processor (e.g., a processor of processor(s) 210). In some cases, a user may interact with a device via input/output device(s) 220 or via hardware components controlled by input/output device(s) 220.

Controller 208 may be an autonomous or assisted driving controller (e.g., an ADAS) configured to control operation of processing system 200 (e.g., including the operation of a vehicle). For example, controller 208 may control acceleration, braking, and/or navigation of vehicle through the environment surrounding vehicle. Controller 208 may include one or more processors, e.g., processor(s) 210. Processor(s) 210 may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 210 may be loaded, for example, from memory 260 and may cause processor(s) 210 to perform the operations attributed to processor(s) 210 in this disclosure. In some examples, one or more of processor(s) 210 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 210 may also include one or more sensor processing units associated with LiDAR system 202, camera 204, and/or radar 206. For example, processor(s) 210 may include one or more image signal processors associated with LiDAR 202, camera, and/or radar 206, and/or a navigation processor associated with other sensor, which may include satellite-based positioning system components (e.g., GPS or GLONASS) as well as inertial positioning system components. In some aspects, other sensor may include direct depth sensing sensors, which may function to determine a depth of or distance to objects within the environment surrounding processing system 200 (e.g., surrounding a vehicle).

Processing system 200 also includes memory 260, which is representative of one or more static and/or dynamic memories, such as a dynamic random access memory, a flash-based static memory, and the like. In this example, memory 260 includes computer-executable components, which may be executed by one or more of the aforementioned components of processing system 200.

Examples of memory 260 include random access memory (RAM), read-only memory (ROM), or a hard disk. Examples of memory 260 include solid state memory and a hard disk drive. In some examples, memory 260 is used to store computer-readable, computer-executable software including instructions that, when executed, cause a processor to perform various functions described herein. In some cases, memory 260 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 260 store information in the form of a logical state.

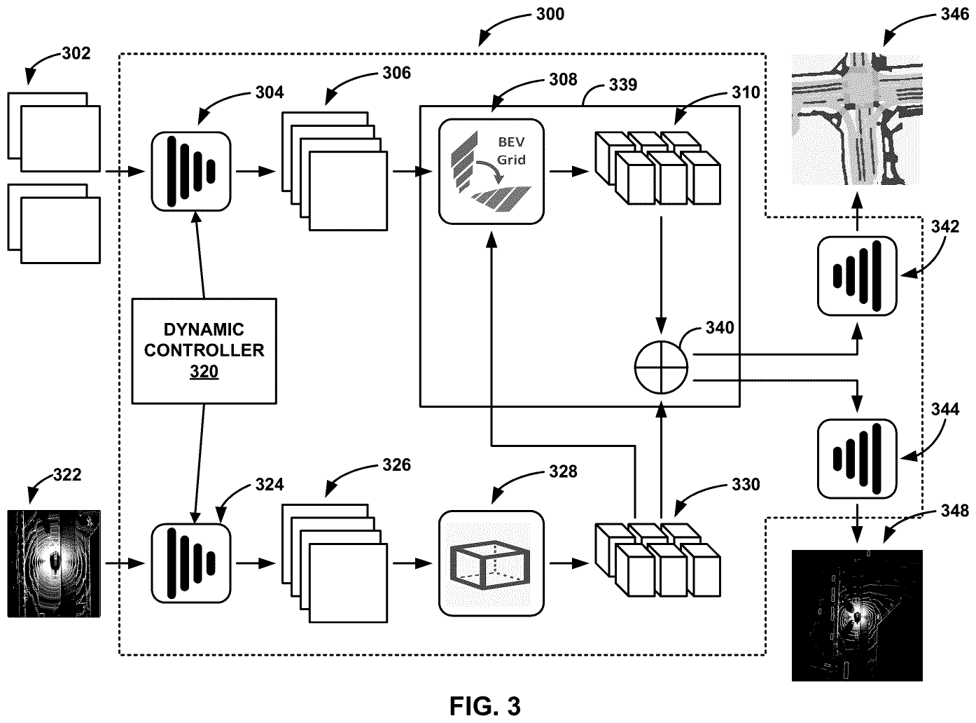

FIG. 3 is a block diagram illustrating an encoder-decoder architecture 300 for processing image data and position data to generate an output, in accordance with one or more techniques of this disclosure. In some examples, encoder-decoder architecture 300 may be a part of ADAS controller 108 FIGS. 1A and 1B or controller 208 of FIG. 2. Where applicable, the techniques of FIG. 3 will be described with respect to processing system 200 of FIG. 2, but it should be understood that encoder-decoder architecture 300 may also be implemented into other systems.

FIG. 3 shows camera images 302, first encoder 304, perspective view features 306, projection unit 308, first set of bird's eye view (BEV) features 310, point cloud frames 322, second encoder 324, 3D sparse features 326, flattening unit 328, second set of BEV features 330, BEV feature fusion unit 340, first decoder 342, second decoder 344, first output 346, and second output 348. Although the techniques of FIG. 3 will be described with respect to camera images 302 and point cloud frames 322, it should be understood that the techniques of FIG. 3 are generally applicable to systems that utilize other frames of data from other modalities of sensors.

Camera images 302 represents a set of camera images acquired by camera system 204. Camera images 302 may be received from a plurality of cameras at different locations and/or different fields of view, which may be overlapping. In some examples, encoder-decoder architecture 300 processes camera images 302 in real time or near real time so that as camera(s) 204 captures camera images 302, encoder-decoder architecture 300 processes the captured camera images. In some examples, camera images 302 may represent one or more perspective views of one or more objects within a 3D space where processing system 200 is located. That is, the one or more perspective views may represent views from the perspective of processing system 200.

Encoder-decoder architecture 300 includes encoders 304, 324 and decoders 342, 344. Encoder-decoder architecture 300 may be configured to process image data and position data (e.g., point cloud data). An encoder-decoder architecture for image feature extraction is commonly used in computer vision tasks, such as image captioning, image-to-image translation, and image generation. The encoder-decoder architecture may transform input data into a compact and meaningful representation known as a feature vector that captures salient visual information from the input data. The encoder may extract features from the input data, while the decoder reconstructs the input data from the learned features.

In some cases, an encoder is built using convolutional neural network (CNN) layers to analyze input data in a hierarchical manner. The CNN layers may apply filters to capture local patterns and gradually combine them to form higher-level features. Each convolutional layer extracts increasingly complex visual representations from the input data. These representations may be compressed and down sampled through operations such as pooling or strided convolutions, reducing spatial dimensions while preserving desired information. The final output of the encoder may represent a flattened feature vector that encodes the input data's high-level visual features.

A decoder may be built using transposed convolutional layers or fully connected layers, and may reconstruct the input data from the learned feature representation. A decoder may take the feature vector obtained from the encoder as input and processes it to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During a training phase, usually prior to deployment, an encoder-decoder architecture for feature extraction may be trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Encoders and decoders of encoder-decoder architecture 300 may be trained using various training data.

An encoder-decoder architecture for image and/or position feature extraction may comprise one or more encoders that extract high-level features from the input data and one or more decoders that reconstruct the input data from the learned features. This architecture may allow for the transformation of input data into compact and meaningful representations. The encoder-decoder framework may enable the model to learn and utilize important visual and positional features, facilitating tasks like image generation, captioning, and translation.

First encoder 304 may represent an encoder of a neural network or another kind of model that is configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

In some examples, the first encoder 304 represents a CNN, another kind of artificial neural network (ANN), or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

First encoder 304 may generate a set of perspective view features 306 based on camera images 302. Perspective view features 306 may provide information corresponding to one or more objects depicted in camera images 302 from the perspective of camera(s) 104 which captures camera images 302. For example, perspective view features 306 may include vanishing points and vanishing lines that indicate a point at which parallel lines converge or disappear, a direction of dominant lines, a structure or orientation of objects, or any combination thereof. Perspective view features 306 may include color information. Additionally, or alternatively, perspective view features 306 may include key points that are matched across a group of two or more camera images of camera images 302. Key points may allow encoder-decoder architecture 300 to determine one or more characteristics of motion and pose of objects. Perspective view features 306 may, in some examples, include depth-based features that indicate a distance of one or more objects from the camera, but this is not required. Perspective view features 306 may include any one or combination of image features that indicate characteristics of camera images 302.

It may be beneficial for encoder-decoder architecture 300 to transform perspective view features 306 into BEV features that represent the one or more objects within the 3D environment on a grid from a perspective looking down at the one or more objects from a position above the one or more objects. Since encoder-decoder architecture 300 may be part of an ADAS for controlling a vehicle, and since vehicles move generally across the ground in a way that is observable from a bird's eye perspective, generating BEV features may allow a control unit (e.g., controller 208 of processing system 200) of FIG. 2 to control the vehicle based on the representation of the one or more objects from a bird's eye perspective. Encoder-decoder architecture 300 is not limited to generating BEV features for controlling a vehicle. Encoder-decoder architecture 300 may generate BEV features for controlling another object such as a robotic arm and/or perform one or more other tasks involving image segmentation, depth detection, object detection, or any combination thereof.

Projection unit 308 may transform perspective view features 306 into a first set of BEV features 310. In some examples, projection unit 308 may generate a 2D grid and project the perspective view features 306 onto the 2D grid. For example, projection unit 308 may perform perspective transformation to place objects closer to the camera on the 2D grid and place objects further form the camera on the 2D grid. In some examples, the 2D grid may include a predetermined number of rows and a predetermined number of columns, but this is not required. Projection unit 308 may, in some examples, set the number of rows and the number of columns. In any case, projection unit 308 may generate the first set of BEV features 310 that represent information present in perspective view features 306 on a 2D grid including the one or more objects from a perspective above the one or more objects looking down at the one or more objects.

In some examples, projection unit 308 may use one or more self-attention blocks and/or cross-attention blocks to transform perspective view features 306 into the first set of BEV features 310. Cross-attention blocks may allow projection unit 308 to process different regions and/or objects of perspective view features 306 while considering relationships between the different regions and/or objects. Self-attention blocks may capture long-range dependencies within perspective view features 306. This may allow a BEV representation of the perspective view features 306 (e.g., the first set of BEV features 310) to capture relationships and dependencies between different elements, objects, and regions in the BEV representation.

Point cloud frames 322 may be examples of point cloud frames 266 of FIG. 2. In some examples, point cloud frames 322 may represent a set of camera images from point cloud frames 166 and point cloud frames 166 may include one or more point cloud frames that are not present in point cloud frames 322. In some examples, encoder-decoder architecture 300 processes point cloud frames 322 in real time or near real time so that as LiDAR system 202 generates point cloud frames 322, encoder-decoder architecture 300 processes the captured point cloud frames. In some examples, point cloud frames 322 may represent collections of point coordinates within a 3D space (e.g., x, y, z coordinates within a Cartesian space) where LiDAR system 202 is located. Since LiDAR system 202 is configured to emit light signals and receive light signals reflected off surfaces of one or more objects, the collections of point coordinates may indicate a shape and a location of surfaces of the one or more objects within the 3D space.

Second encoder 324 may represent an encoder of a neural network or another kind of model that is configured to extract information from input data and process the extracted information to generate an output. Second encoder 324 may be similar to first encoder 304 in that both the first encoder 304 and the second encoder 324 are configured to process input data to generate output features. But in some examples, first encoder 304 is configured to process 2D input data and second encoder 324 is configured to process 3D input data. In some examples, processing system 200 is configured to train first encoder 304 using a set of training data of training data 170 that includes one or more training camera images and processing system 200 is configured to train second encoder 324 using a set of training data of training data 170 that includes one or more point cloud frames. That is, processing system 200 may train first encoder 304 to recognize one or more patterns in camera images that correspond to certain camera image perspective view features and processing system 200 may train second encoder 324 to recognize one or more patterns in point cloud frames that correspond to certain 3D sparse features.

Second encoder 324 may generate a set of 3D sparse features 326 based on point cloud frames 322. 3D sparse features 326 may provide information corresponding to one or more objects indicated by point cloud frames 322 within a 3D space that includes LiDAR system 202 which captures point cloud frames 322. 3D sparse features 326 may include key points within point cloud frames 322 that indicate unique characteristics of the one or more objects. For example, key points may include corners, straight edges, curved edges, peaks of curved edges. Encoder-decoder architecture 300 may recognize one or more objects based on key points. 3D sparse features 326 may additionally or alternatively include descriptors that allow second encoder 324 to compare and track key points across groups of two or more point cloud frames of point cloud frames 322. Other kids of 3D sparse features 326 include voxels and super pixels.

Flattening unit 328 may transform 3D sparse features 326 into a second set of BEV features 330. In some examples, flattening unit 328 may define a 2D grid of cells and project the 3D sparse features onto the 2D grid of cells. For example, flattening unit 328 may project 3D coordinates of 3D sparse features (e.g., cartesian coordinates key points, voxels) onto a corresponding 2D coordinate of the 2D grid of cells. Flattening unit 328 may aggregate one or more sparse features within each cell of the 2D grid of cells. For example, flattening unit 328 may count a number of features within a cell, average attributes of features within a cell, or take a minimum or maximum value of a feature within a cell. Flattening unit 328 may normalize the features within each cell of the 2D grid of cells, but this is not required. Flattening unit 328 may flatten the features within each cell of the 2D grid of cells into a 2D array representation that captures characteristics of the 3D sparse features projected into each cell of the 2D grid of cells.

Since point cloud frames 322 represent multi-dimensional arrays of cartesian coordinates, flattening unit 328 may generate the second set of BEV features 330 by compressing one of the dimensions of the x, y, z cartesian space into a flattened plane without compressing the other two dimensions. That is, the points within a column of points parallel to one of the dimensions of the x, y, z cartesian space may be compressed into a single point on a 2D space formed by the two dimensions that are not compressed. Perspective view features 306 extracted from camera images 302, on the other hand, might not include cartesian coordinates. This means that it may be beneficial for projection unit 308 to receive the second set of BEV features 330 to aid in projecting perspective view features 306 onto a 2D BEV space to generate the first set of BEV features 310.

Projection unit 308 may generate the first set of BEV features 310 in a way that weighs an importance of image data for indicating characteristics of the 3D environment corresponding to processing system 200 and an importance of position data for indicating characteristics of the 3D environment corresponding to processing system 200. Image data may include information corresponding to one or more objects within the 3D environment that is not present in position data, and position data may include one information corresponding to one or more objects within the 3D environment that is not present in image data.

In some cases, information present in image data that is not present in position data is more important for generating an output to perform one or more tasks, and in other cases, information present in image data that is not present in position data is less important for generating an output to perform one or more tasks. In some cases, information present in position data that is not present in image data is more important for generating an output to perform one or more tasks, and in other cases, information present in position data that is not present in image data is less important for generating an output to perform one or more tasks. This means that it may be beneficial for projection unit 308 to generate the first set of BEV features 310 to account for the relevant importance of image data and position data for indicating characteristics of the 3D environment that are useful for generating an output.

To account for the relative importance of image data and position data for identifying characteristics of the 3D environment that are useful for generating an output to perform one or more tasks, projection unit 308 may condition perspective view features 306 extracted from camera images 302 and condition the second set of BEV features 330 generated from the 3D sparse features 326 extracted from point cloud frames 322 to determine a weighted summation. This weighted summation may indicate the relative importance of camera images 302 and the relative importance of point cloud frames 322 for generating an output to perform one or more tasks. Projection unit 308 may use the weighted summation to generate the first set of BEV features 310 to account for the relative importance of camera images 302 and the relative importance of point cloud frames 322 for generating an output to perform one or more tasks.

In some examples, point cloud frames 322 may include more precise position information indicating a location of one or more objects within the 3D environment, and camera images 302 may include less precise information concerning the position of one or more objects. For example, point cloud frames 322 may indicate a precise location, in Cartesian coordinates, of two objects. The Cartesian coordinates may indicate a precise distance of each of the two objects from LiDAR system 202. Camera images 302 may depict visual characteristics of each of the two objects including color, texture, and shape information, but might not include information concerning the precise distance of each of the two objects from camera(s) 104. Camera images 302 may indicate that one of the objects is between the other object and camera(s) 104, but might not indicate precise distances.

Projection unit 308 may condition perspective view features 306 and condition the second set of BEV features 330 to determine the weighted summation so that the first set of BEV features 310 indicates more useful information corresponding to each object of one or more objects within the 3D environment as compared with BEV features generated using other techniques. For example, when the precise location of a pedestrian is important for generating an output to control a vehicle, the weighted summation may weight position data features more heavily than the weighted summation weights image data features for indicating characteristics of the pedestrian in the first set of BEV features 310. When the text on a traffic sign and/or the color of a stoplight is important for generating an output to control a vehicle, the weighted summation may weight image data features more heavily than the weighted summation weights position data features for indicating characteristics of the traffic sign and/or the stoplight for indicating characteristics of the traffic sign and/or the stoplight in the first set of BEV features 310. That is, the weighted summation may weight the relative importance of image data and position data for indicating the characteristic of each object and/or each region of one or more objects and regions in the 3D environment. This may ensure that the set of BEV features 310 include more relevant information concerning the 3D environment for generating an output to perform one or more tasks as compared with BEV features generated using other techniques.

To condition perspective view features 306 and condition the second set of BEV features 330, projection unit 308 may use one or more positional encoding models trained using training data. For example, projection unit 308 may use a first positional encoding model to condition perspective view features 306 and use the first positional encoding model to condition the second set of BEV features 330. Based on the conditioned perspective view features 306, the conditioned second set of BEV features 330, and the first positional encoding model, projection unit 308 may determine the weighted summation. Additionally, or alternatively, projection unit 308 may use a second feature conditioning module to condition the perspective view features 306. Based on the weighted summation, perspective view features 306, and/or the conditioned perspective view features 306 conditioned using the second positional encoding model, projection unit 308 may generate the first set of BEV features 310.

In some examples, a projection and fusion unit 339 may include projection unit 308 and BEV feature fusion unit 340. BEV feature fusion unit 340 may be configured to fuse the first set of BEV features 310 and the second set of BEV features 330 to generate a fused set of BEV features. In some examples, BEV feature fusion unit 340 may use a concatenation operation to fuse the first set of BEV features 310 and the second set of BEV features 330. The concatenation operation may combine the first set of BEV features 310 and the second set of BEV features 330 so that the fused set of BEV features includes useful information present in each of the first set of BEV features 310 and the second set of BEV features 330. By using projection unit 308 to generate the first set of BEV features 310 to indicate the relative importance of each of position data and image data for indicating characteristics of the 3D environment, BEV feature fusion unit 340 may be configured to fuse the first set of BEV features 310 and the second set of BEV features 330 in a way that indicates a greater amount of useful information for generating an output as compared with systems that do not generate BEV features for image data to account for the relative importance of image data and position data.

Encoder-decoder architecture 300 may include first decoder 342 and second decoder 344. In some examples, each of first decoder 342 and second decoder 344 may represent a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more spatial dimensions of the features, increase a complexity of the features, or increase a resolution of the features. A final layer of a decoder may generate a reconstructed output that includes an expanded representation of the features extracted by an encoder.

First decoder 342 may be configured to generate a first output 346 based on the fused set of BEV features. The first output 346 may comprise a 2D BEV representation of the 3D environment corresponding to processing system 200. For example, when processing system 200 is part of an ADAS for controlling a vehicle, the first output 346 may indicate a BEV view of one or more roads, road signs, road markers, traffic lights, vehicles, pedestrians, and other objects within the 3D environment corresponding to processing system 200. This may allow processing system 200 to use the first output 346 to control the vehicle within the 3D environment.

Since the output from first decoder 342 includes a bird's eye view of one or more objects that are in a 3D environment corresponding to encoder-decoder architecture 300, a control unit (e.g., controller 208 of FIG. 2) may use the output from first decoder 342 to control an object (e.g., a vehicle, one or more robotic components) within the 3D environment. For example, when the output from first decoder 342 indicates a vehicle ahead of a vehicle corresponding to processing system 200, the control unit may control the vehicle to change lanes to pass the other vehicle. In another example, when the output from first decoder 342 indicates a stop sign ahead, the control unit may control the vehicle to stop at an intersection.

Second decoder 344 may be configured to generate a second output 348 based on the fused set of BEV features. In some examples, the second output 348 may include a set of 3D bounding boxes that indicate a shape and a position of one or more objects within a 3D environment. In some examples, it may be important to generate 3D bounding boxes to determine an identity of one or more objects and/or a location of one or more objects. When processing system 200 is part of an ADAS for controlling a vehicle, processing system 200 may use the second output 348 to control the vehicle within the 3D environment. A control unit (e.g., controller 208 of FIG. 2) may process the second output 348 to perform one or more actions.

According to the techniques of this disclosure, the CNNs implemented by first encoder 304 and second encoder 324 may be DNNs that dynamically update during runtime, i.e., after an initial training phase. Dynamic controller 320 may be configured to determine a first delay associated with determining perspective view features 306, determine a second delay associated with determining 3D sparse features 326, and modify a topology of the CNN of one or both of first encoder 304 and second encoder 324. To determine the first delay, dynamic controller 320 may, for example, determine a first total delay corresponding to a sum of a first inference delay for the CNN of first encoder 304 and a first time-of-issue delay for cameras 204 to capture camera images 302. To determine the second delay, dynamic controller 320 may also determine a second total delay corresponding to a sum of a second inference delay for the CNN of second encoder 324 and a second time-of-issue delay for LiDAR 292 to capture point cloud frames 322. Dynamic controller 320 may then modify the topology of the CNN of first encoder 304 and/or the CNN of second encoder 324, such that the first total delay and the second total delay are closer.

In some examples, if the first total delay is greater than the second total delay, then dynamic controller 320 may, for example, reduce a number of layers being used by the CNN of first encoder 304 or change a depth of the CNN being used by first encoder 304. In other examples, if the second total delay is greater than the first total delay, then dynamic controller 320 may, for example, reduce a number of layers being used by the CNN of second encoder 324 or reduce a depth of the CNN being used by second encoder 324. In other examples, if the first total delay is greater than the second total delay, then dynamic controller 320 may, for example, mask an input to the CNN of first encoder 304 such that the amount of data being processed by the CNN of the first encoder 304 is reduced. In other examples, if the second total delay is greater than the first total delay, then dynamic controller 320 may, for example, mask an input to the CNN of second encoder 324 such that the amount of data being processed by the CNN of the second encoder is reduced.

The examples above generally describe scenarios where the topology of one CNN is modified to improve synchronicity by reducing the delay associated with the modified CNN. In other examples, however, the topology of a CNN may be increased to improve synchronicity or the topologies of multiple CNNs may be modified to improve synchronicity.

Dynamic controller 320 may, for example, include a dynamic time delay measurement unit that receives camera images 302, point cloud frames 322, and potentially other frames of data as well, and also receives time of issue information from the respective sensors. Based on the respective time of issue information, as well as a respective time of receipt, dynamic controller 320 may determine delays for various sensors. Based on the determined delays, dynamic controller 320 may control a topology of the CNN used by first encoder 304 and/or second encoder 324. The CNN of first encoder 304 may, for example, include layers, modules, or branches that are either preserved or skipped based on the delay determined by dynamic controller 320, and the CNN of second encoder 324 may likewise, additionally or alternatively, include layers, modules, or branches that are either preserved or skipped based on the delay determined by dynamic controller 320.

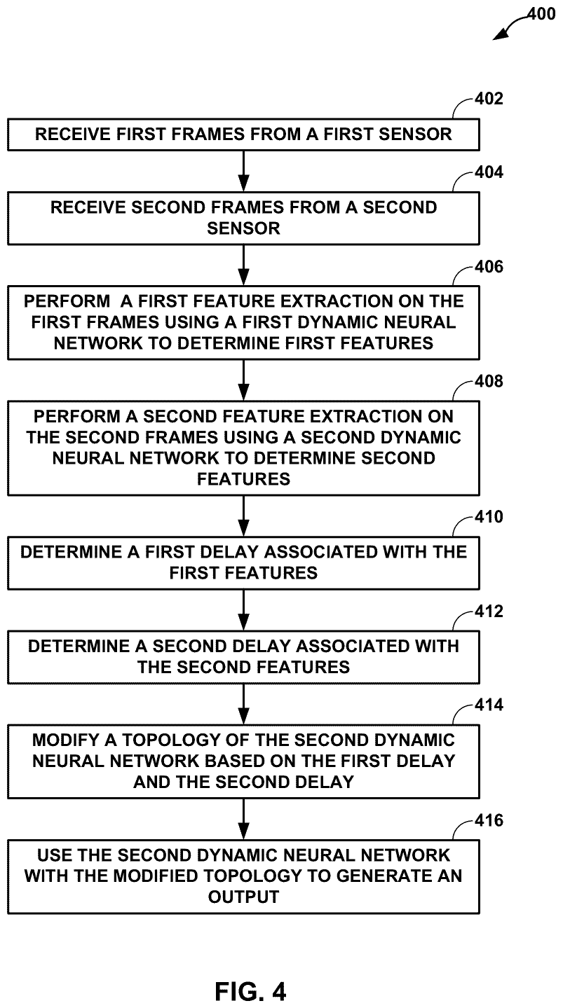

FIG. 4 is a flowchart illustrating an example process 400 for modifying a DNN of an ADAS during runtime. The process of FIG. 4 will be described with respect to processing system 200 of FIG. 2, but the techniques of FIG. 4 are not limited to any particular system. Controller 208 receives first frames from a first sensor (402). The first sensor may, for example, be any of LiDAR 202, camera 204, radar 206, or some other sensor. Controller 208 receives second frames from a second sensor (404). The second sensor may, for example, be any of LiDAR 202, camera 204, radar 206, or some other sensor, and may be of the same or a different modality as the first sensor. Controller 208 performs a first feature extraction on the first frames using a first DNN of DNNS 240 to determine first features (406). Controller 208 performs a second feature extraction on the second frames using a second DNN of DNNS 240 to determine second features (408).

Controller 208 determines a first delay associated with the first features (410) and determines a second delay associated with the second features (412). The first delay may, for example, be, or include, a first inference delay that corresponds to a time required to perform the feature extraction on the first frames using the first DNN, and the second delay may, for example, be, or include, a second inference delay corresponding to a time required to perform the feature extraction on the second frames using the second DNN. The first delay may also be, or include, a first time-of-issue delay corresponding to a time required for the first frames to be transmitted from the first sensor to the processing circuitry, and the second delay may be, or include, a second time-of-issue delay corresponding to a time required for the second frames to be transmitted from the second sensor to the processing circuitry. The first delay may also be, or include, a first total delay that is the sum of the first inference delay and the first time-of-issue delay, and the second delay may be, or include, a second total delay that is the sum of the second inference delay and the second time-of-issue delay.

Controller 208 modifies a topology of the second DNN based on the first delay and the second delay (414). Controller 208 may, for example, modify the topology of the second DNN by reducing a number of layers being used by the second DNN, changing a depth of the second DNN, disabling a module of the second dynamic neural network, or enabling a mask of the second DNN. In other examples, controller 208 may additionally or alternatively modify a topology of the first DNN.

Generally speaking, controller 208 may modify the topology of the first DNN and/or the topology of the second DNN, such that the difference between the first and second delay is decreased. If, for example, the second delay is greater than the first delay, then controller 208 may, for example, modify the topology of the second DNN to reduce the second delay or modify the topology of the first DNN to increase the delay of the first DNN.

For subsequent frames received from the second sensor, controller 208 may usc the second DNN with the modified topology to generate an output (416). The output may, for example, be a control signal for an adaptive cruise control, lane keeping assist, pedestrian detection, automatic emergency braking, parking assistance, or some other such navigation function.

To modify the topology of the second DNN, controller 208 may dynamically drop layers, branches, and or modules of the second DNN, such that the inference delay of the second DNN decreases, and thus, the difference in total delays associated with the first feature and the second feature also decrease. Controller 208 may also dynamically change the output of a branch using masks. The mask may, for example, reduce the amount of data being input into a layer, such that the amount of time required to perform the operation of the layer is reduced.

The following numbered clauses illustrate one or more aspects of the devices and techniques described in this disclosure.

Clause 1: A system comprising: one or more memories configured to store first frames of data and second frames of data; and processing circuitry configured to: receive the first frames from a first sensor; receive the second frames from a second sensor; perform a first feature extraction on the first frames using a first dynamic neural network to determine first features; perform a second feature extraction on the second frames using a second dynamic neural network to determine second features; determine a first delay associated with the first features; determine a second delay associated with the second features; modify a topology of the second dynamic neural network based on the first delay and the second delay; and use the second dynamic neural network with the modified topology to generate an output.

Clause 2: The system of clause 1, wherein to modify the topology of the second dynamic neural network, the processing circuitry is configured to reduce a number of layers being used by the second dynamic neural network.

Clause 3: The system of clause 1 or 2, wherein to modify the topology of the second dynamic neural network, the processing circuitry is configured to change a depth of the second dynamic neural network.

Clause 4: The system of any of clauses 1-3, wherein to modify the topology of the second dynamic neural network, the processing circuitry is configured to disable a module of the second dynamic neural network.

Clause 5: The system of any of clauses 1-4, wherein to modify the topology of the second dynamic neural network, the processing circuitry is configured to enable a mask of the second dynamic neural network.

Clause 6: The system of any of clauses 1-5, wherein the processing circuitry is further configured to: determine a first inference delay, wherein the first inference delay corresponds to a time required to perform the feature extraction on the first frames using the first dynamic neural network; determine the first delay based on the first inference delay; determine a second inference delay, wherein the second inference delay corresponds to a time required to perform the feature extraction on the second frames using the second dynamic neural network; and determine the second delay based on the second inference delay.

Clause 7: The system of any of clauses 1-6, wherein the processing circuitry is further configured to: determine a first time-of-issue delay, wherein the first time-of-issue delay comprises a time required for the first frames to be transmitted from the first sensor to the processing circuitry; determine the first delay based on the first time-of-issue delay; determine a second time-of-issue delay, wherein the second time-of-issue delay comprises a time required for the second frames to be transmitted from the second sensor to the processing circuitry; and determine the second delay based on the second time-of-issue delay.

Clause 8: The system of any of clauses 1-4, wherein the processing circuitry is further configured to: determine a first total delay, wherein the first total delay comprises a sum of a first inference delay and a first time-of-issue delay, wherein the first inference delay corresponds to a time required to perform the feature extraction on the first frames using the first dynamic neural network, and the first time-of-issue delay comprises a time required for the first frames to be transmitted from the first sensor to the processing circuitry; determine the first delay based on the first total delay; determine a second total delay, wherein the second total delay comprises a sum of a second inference delay and a second time-of-issue delay, wherein the second inference delay corresponds to a time required to perform the feature extraction on the second frames using the second dynamic neural network, and the second time-of-issue delay comprises a time required for the second frames to be transmitted from the second sensor to the processing circuitry; determine the second delay based on the second total delay.

Clause 9: The system of any of clauses 1-8, wherein the first sensor comprises a camera, and the first frames comprise images.

Clause 10: The system of any of clauses 1-8, wherein the first sensor comprises a LiDAR, and the first frames comprise point cloud frames.

Clause 11: The system of any of clauses 1-8, wherein the first sensor comprises a radar, and the first frames comprise scans.

Clause 12: The system of any of clauses 1-11, wherein to use the second dynamic neural network with the modified topology to generate the output, the processing circuitry is further configured to: receive third frames from the first sensor; receive fourth frames from the second sensor; perform feature extraction on the third frames using the first dynamic neural network; perform feature extraction on the fourth frames using the second dynamic neural network with the modified topology; and generate the output based on the feature extraction of the third frames and the feature extraction.

Clause 13: The system of any of clauses 1-12, wherein the output comprises an automatic navigation operation.

Clause 14: The system of any of clauses 1-13, wherein the processing circuitry is part of an advanced driver assistance system (ADAS).

Clause 15: The system of any of clauses 1-13, wherein the processing circuitry is external to an advanced driver assistance system (ADAS), and wherein the processing circuitry is configured to transmit the output to the ADAS.

Clause 16: A method comprising: receiving, at processing circuitry, first frames from a first sensor; receiving, at the processing circuitry, second frames from a second sensor; performing a first feature extraction on the first frames using a first dynamic neural network to determine first features; performing a second feature extraction on the second frames using a second dynamic neural network to determine second features; determining a first delay associated with the first features; determining a second delay associated with the second features; modifying a topology of the second dynamic neural network based on the first delay and the second delay; and using the second dynamic neural network with the modified topology to generate an output.

Clause 17: The method of clause 16, wherein modifying the topology of the second dynamic neural network, comprises reducing a number of layers being used by the second dynamic neural network.

Clause 18: The method of clause 16 or 17, wherein modifying the topology of the second dynamic neural network comprises changing a depth of the second dynamic neural network.

Clause 19: The method of any of clauses 16-18, wherein modifying the topology of the second dynamic neural network comprises disabling a module of the second dynamic neural network.

Clause 20: The method of any of clauses 16-19, wherein modifying the topology of the second dynamic neural network comprises enabling a mask of the second dynamic neural network.

Clause 21: The method of any of clauses 16-21, further comprising: determining a first inference delay, wherein the first inference delay corresponds to a time required to perform the feature extraction on the first frames using the first dynamic neural network; determining the first delay based on the first inference delay; determining a second inference delay, wherein the second inference delay corresponds to a time required to perform the feature extraction on the second frames using the second dynamic neural network; and determining the second delay based on the second inference delay.

Clause 22: The method of any of clauses 16-21, further comprising: determining a first time-of-issue delay, wherein the first time-of-issue delay comprises a time required for the first frames to be transmitted from the first sensor to the processing circuitry; determining the first delay based on the first time-of-issue delay; determining a second time-of-issue delay, wherein the second time-of-issue delay comprises a time required for the second frames to be transmitted from the second sensor to the processing circuitry; and determining the second delay based on the second time-of-issue delay.

Clause 23: The method of any of clauses 16-20, further comprising: determining a first total delay, wherein the first total delay comprises a sum of a first inference delay and a first time-of-issue delay, wherein the first inference delay corresponds to a time required to perform the feature extraction on the first frames using the first dynamic neural network, and the first time-of-issue delay comprises a time required for the first frames to be transmitted from the first sensor to the processing circuitry; determining the first delay based on the first total delay; determining a second total delay, wherein the second total delay comprises a sum of a second inference delay and a second time-of-issue delay, wherein the second inference delay corresponds to a time required to perform the feature extraction on the second frames using the second dynamic neural network, and the second time-of-issue delay comprises a time required for the second frames to be transmitted from the second sensor to the processing circuitry; determining the second delay based on the second total delay.

Clause 24: The method of any of clauses 16-23, wherein the first sensor comprises a camera and the first frames comprise images.

Clause 25: The method of any of clauses 16-23, wherein the first sensor comprises a LiDAR and the first frames comprise point cloud frames.

Clause 26: The method of any of clauses 16-23, wherein the first sensor comprises a radar and the first frames comprise scans.

Clause 27: The method of any of clauses 16-26, wherein using the second dynamic neural network with the modified topology to generate the output comprises: receiving third frames from the first sensor; receiving fourth frames from the second sensor; performing feature extraction on the third frames using the first dynamic neural network; performing feature extraction on the fourth frames using the second dynamic neural network with the modified topology; and generating the output based on the feature extraction of the third frames and the feature extraction.

Clause 28: The method of clause any of clauses 16-27, wherein the output comprises an automatic navigation operation.

Clause 29: The method of any of clauses 16-28, wherein the method is performed by an advanced driver assistance system (ADAS).

Clause 30: The method of any of clauses 16-28, wherein the method is performed by processing circuitry that is external to an advanced driver assistance system (ADAS), and wherein the processing circuitry is configured to transmit the output to the ADAS.

Clause 31: A computer-readable storage medium storing instructions that when executed by one or more processors cause the one or more processors to: receive first frames from a first sensor; receive second frames from a second sensor; perform a first feature extraction on the first frames using a first dynamic neural network to determine first features; perform a second feature extraction on the second frames using a second dynamic neural network to determine second features; determine a first delay associated with the first features; determine a second delay associated with the second features; modify a topology of the second dynamic neural network based on the first delay and the second delay; and use the second dynamic neural network with the modified topology to generate an output.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
one or more memories configured to store first frames of data and second frames of data; and
processing circuitry configured to:
receive the first frames from a first sensor;
receive the second frames from a second sensor;
perform a first feature extraction on the first frames using a first dynamic neural network to determine first features;
perform a second feature extraction on the second frames using a second dynamic neural network to determine second features;
determine a first delay associated with the first features;
determine a second delay associated with the second features;
modify a topology of the second dynamic neural network based on the first delay and the second delay; and
use the second dynamic neural network with the modified topology to generate an output.

2. The system of claim 1, wherein to modify the topology of the second dynamic neural network, the processing circuitry is configured to reduce a number of layers being used by the second dynamic neural network.

3. The system of claim 1, wherein to modify the topology of the second dynamic neural network, the processing circuitry is configured to change a depth of the second dynamic neural network.

4. The system of claim 1, wherein to modify the topology of the second dynamic neural network, the processing circuitry is configured to disable a module of the second dynamic neural network.

5. The system of claim 1, wherein to modify the topology of the second dynamic neural network, the processing circuitry is configured to enable a mask of the second dynamic neural network.

6. The system of claim 1, wherein the processing circuitry is further configured to:
determine a first inference delay, wherein the first inference delay corresponds to a time required to perform the feature extraction on the first frames using the first dynamic neural network;
determine the first delay based on the first inference delay;
determine a second inference delay, wherein the second inference delay corresponds to a time required to perform the feature extraction on the second frames using the second dynamic neural network; and
determine the second delay based on the second inference delay.

7. The system of claim 1, wherein the processing circuitry is further configured to:
determine a first time-of-issue delay, wherein the first time-of-issue delay comprises a time required for the first frames to be transmitted from the first sensor to the processing circuitry;
determine the first delay based on the first time-of-issue delay;
determine a second time-of-issue delay, wherein the second time-of-issue delay comprises a time required for the second frames to be transmitted from the second sensor to the processing circuitry; and
determine the second delay based on the second time-of-issue delay.

8. The system of claim 1, wherein the processing circuitry is further configured to:
determine a first total delay, wherein the first total delay comprises a sum of a first inference delay and a first time-of-issue delay, wherein the first inference delay corresponds to a time required to perform the feature extraction on the first frames using the first dynamic neural network, and the first time-of-issue delay comprises a time required for the first frames to be transmitted from the first sensor to the processing circuitry;
determine the first delay based on the first total delay;
determine a second total delay, wherein the second total delay comprises a sum of a second inference delay and a second time-of-issue delay, wherein the second inference delay corresponds to a time required to perform the feature extraction on the second frames using the second dynamic neural network, and the second time-of-issue delay comprises a time required for the second frames to be transmitted from the second sensor to the processing circuitry;
determine the second delay based on the second total delay.

9. The system of claim 1, wherein the first sensor comprises a camera, and the first frames comprise images.

10. The system of claim 1, wherein the first sensor comprises a LiDAR, and the first frames comprise point cloud frames.

11. The system of claim 1, wherein the first sensor comprises a radar, and the first frames comprise scans.

12. The system of claim 1, wherein to use the second dynamic neural network with the modified topology to generate the output, the processing circuitry is further configured to:
receive third frames from the first sensor;
receive fourth frames from the second sensor;
perform feature extraction on the third frames using the first dynamic neural network;
perform feature extraction on the fourth frames using the second dynamic neural network with the modified topology; and
generate the output based on the feature extraction of the third frames and the feature extraction.

13. The system of claim 1, wherein the output comprises an automatic navigation operation.

14. The system of claim 1, wherein the processing circuitry is part of an advanced driver assistance system (ADAS).

15. The system of claim 1, wherein the processing circuitry is external to an advanced driver assistance system (ADAS), and wherein the processing circuitry is configured to transmit the output to the ADAS.

16. A method comprising:
receiving, at processing circuitry, first frames from a first sensor;
receiving, at the processing circuitry, second frames from a second sensor;
performing a first feature extraction on the first frames using a first dynamic neural network to determine first features;
performing a second feature extraction on the second frames using a second dynamic neural network to determine second features;
determining a first delay associated with the first features;
determining a second delay associated with the second features;
modifying a topology of the second dynamic neural network based on the first delay and the second delay; and
using the second dynamic neural network with the modified topology to generate an output.

17. The method of claim 16, wherein modifying the topology of the second dynamic neural network, comprises reducing a number of layers being used by the second dynamic neural network.

18. The method of claim 16, wherein modifying the topology of the second dynamic neural network comprises changing a depth of the second dynamic neural network.

19. The method of claim 16, wherein modifying the topology of the second dynamic neural network comprises disabling a module of the second dynamic neural network.

20. The method of claim 16, wherein modifying the topology of the second dynamic neural network comprises enabling a mask of the second dynamic neural network.

21. The method of claim 16, further comprising:
determining a first inference delay, wherein the first inference delay corresponds to a time required to perform the feature extraction on the first frames using the first dynamic neural network;
determining the first delay based on the first inference delay;
determining a second inference delay, wherein the second inference delay corresponds to a time required to perform the feature extraction on the second frames using the second dynamic neural network; and
determining the second delay based on the second inference delay.

22. The method of claim 16, further comprising:
determining a first time-of-issue delay, wherein the first time-of-issue delay comprises a time required for the first frames to be transmitted from the first sensor to the processing circuitry;
determining the first delay based on the first time-of-issue delay;
determining a second time-of-issue delay, wherein the second time-of-issue delay comprises a time required for the second frames to be transmitted from the second sensor to the processing circuitry; and
determining the second delay based on the second time-of-issue delay.

23. The method of claim 16, further comprising:
determining a first total delay, wherein the first total delay comprises a sum of a first inference delay and a first time-of-issue delay, wherein the first inference delay corresponds to a time required to perform the feature extraction on the first frames using the first dynamic neural network, and the first time-of-issue delay comprises a time required for the first frames to be transmitted from the first sensor to the processing circuitry;
determining the first delay based on the first total delay;
determining a second total delay, wherein the second total delay comprises a sum of a second inference delay and a second time-of-issue delay, wherein the second inference delay corresponds to a time required to perform the feature extraction on the second frames using the second dynamic neural network, and the second time-of-issue delay comprises a time required for the second frames to be transmitted from the second sensor to the processing circuitry;
determining the second delay based on the second total delay.

24. The method of claim 16, wherein the first sensor comprises a camera and the first frames comprise images.

25. The method of claim 16, wherein the first sensor comprises a LiDAR and the first frames comprise point cloud frames.

26. The method of claim 16, wherein the first sensor comprises a radar and the first frames comprise scans.

27. The method of claim 16, wherein using the second dynamic neural network with the modified topology to generate the output comprises:
receiving third frames from the first sensor;
receiving fourth frames from the second sensor;
performing feature extraction on the third frames using the first dynamic neural network;
performing feature extraction on the fourth frames using the second dynamic neural network with the modified topology; and
generating the output based on the feature extraction of the third frames and the feature extraction.

28. The method of claim 16, wherein the output comprises an automatic navigation operation.

29. The method of claim 16, wherein the method is performed by an advanced driver assistance system (ADAS).

30. A computer-readable storage medium storing instructions that when executed by one or more processors cause the one or more processors to:
receive first frames from a first sensor;
receive second frames from a second sensor;
perform a first feature extraction on the first frames using a first dynamic neural network to determine first features;
perform a second feature extraction on the second frames using a second dynamic neural network to determine second features;
determine a first delay associated with the first features;
determine a second delay associated with the second features;
modify a topology of the second dynamic neural network based on the first delay and the second delay; and
use the second dynamic neural network with the modified topology to generate an output.
